(19) United States
(12) Patent Application Publication
(10) Pub. No.: US 2026/0310322 A1
(43) Pub. Date: Oct. 8, 2026

(54) DIFFERENTIAL CAPACITANCE SENSING INTERFACES

(71) Applicant: AZOTEQ HOLDINGS LIMITED, Nicosia (CY)

(72) Inventors: Frederick Johannes BRUWER, Paarl (ZA); Daniël Barend RADEMEYER, Paarl (ZA); Jean VILJOEN, Paarl (ZA); Jacobus Nicolaas LOCHNER, Paarl (ZA); Chris Hendrik DE JONGH, Paarl (ZA)

(21) Appl. No.: 19/638,387

(22) Filed: Apr. 3, 2026

(30) Foreign Application Priority Data
Apr. 4, 2025 (ZA) 2025/02888
Apr. 24, 2025 (ZA) 2025/03457
May 21, 2025 (ZA) 2025/04304

(51) Int. Cl. G06F 3/044; G06F 3/023; G06F 3/0338; G06F 3/0354; G06F 3/0362

(52) U.S. Cl. CPC G06F 3/044; G06F 3/023; G06F 3/0338; G06F 3/03543; G06F 3/0362

(57) ABSTRACT

A differential capacitive sensing system in an electronic device has a movable user interface member. The system has a receiving electrode, a first transmitting electrode forming a first mutual capacitor with the receiving electrode, a second transmitting electrode forming a second mutual capacitor with the receiving electrode, and measurement circuitry which is configured to drive the second transmitting electrode out-of-phase with the first transmitting electrode to perform a subtraction of capacitances relating to the first and second mutual capacitors external to the measurement circuitry. The measurement circuitry is configured to measure the differential capacitance when a capacitive interfering member that is coupled to or is part of the user interface member, interferes with the capacitance of the first or second mutual capacitor due to the movement of the interfering member. The measured differential capacitance is a metric related to the position of the interfering member.

### CROSS-REFERENCE TO RELATED APPLICATION

The present application claims priority from South African application ZA 2025/02888, filed on Apr. 4, 2025, South African application ZA 2025/03457, filed Apr. 24, 2025, and South African application ZA 2025/04304, filed May 21, 2025, the contents of which are hereby incorporated by reference into this application.

### BACKGROUND

The need for improving sensing methods in electronic devices remains a relevant endeavor to address on-going problems such as robustness and sensor sensitivity in modern electronic devices. Contactless sensing technologies such as magnetic sensing methods, which includes Hall-effect, TMR sensors and inductive coil sensors are ideal techniques to improve the robustness of a sensor, especially in view of ohmic and contact sensors which may experience wear-and-tear over time. Magnetic sensors, however, may be expensive to implement and may require the use of polarized magnets, which may interfere with other electronic components around them. Also, these sensors may be prone to external magnetic interference.

Capacitive sensing technology may be regarded as a suitable contactless alternative to magnetic-type sensors, but are known to be susceptible to signal drift due to changing environmental conditions. Known techniques such as disclosed in US20080047764A require the use of a reference capacitive electrode that is monitored separately from the main sensing electrode, in order to track true environmental effects. The disadvantage of this approach is that at least two receiving (Rx) electrode pins are used, leaving less input-output (IO) pins available to other peripherals.

The differential capacitive sensing technique disclosed in US20230118148A1 teaches that it is possible to achieve temperature compensated sensing on a single Rx electrode by using two transmitting (Tx) electrodes that are driven out-of-phase relative to each other. This results in the Rx electrode only reading the difference between the mutual capacitances. The US20230118148A1 disclosure, however, does not teach how the differential sensing techniques can be extended to electronic devices other than wearable devices. It also does not teach how this sensing technique can be used to detect and monitor user interface devices such as keys on a keyboard, the joystick levers on a controller, and so on.

### SUMMARY OF THE INVENTION

It is an objective of this invention to not only improve upon the aforementioned sensing problems, but also to extend the capabilities and advantages of the differential capacitance sensing technique to other electronic devices, wherein said devices have a movable user interface. This user interface may, for example, be a key on a keyboard, or a lever on a joystick/thumb stick device. The use of capacitive sensing may also provide a power efficient alternative to other contactless technologies. For joystick technology specifically, the stick drift problem may be addressed effectively while also benefiting from a low-cost contactless sensing method.

Various embodiments are described herein using a differential capacitive sensing system, wherein the sensing system comprises at least one receiving electrode, a first transmitting electrode and a second transmitting electrode, and also measurement circuitry. The measurement circuitry may drive the Tx electrodes out-of-phase with each other resulting in a subtraction of mutual capacitances outside of the measurement circuitry. The measurement circuitry reads a value on the Rx that is already indicative of the difference in mutual capacitances. This provides substantial benefits for temperature and humidity compensation, while also increasing the SNR and sensing resolution in various applications. These applications include joysticks devices, planar joystick devices, keyboard key switches, rotary dials, computer mouses, force-sensing trackpads.

### BRIEF DESCRIPTION OF THE DRAWINGS

The invention is further described by way of examples with reference to the accompanying drawings in which:

FIG. 1a shows an exemplary differential capacitive sensing system diagram.

FIG. 1b shows an exemplary differential capacitance measurement response.

FIG. 1c shows an exemplary differential capacitive sensing system further comprising bias capacitances.

FIG. 2a shows an exemplary differential capacitance electrode configuration on a support structure.

FIG. 2b shows a side view of the exemplary differential capacitance electrode configuration of FIG. 2a.

FIG. 3a shows an exemplary differential capacitance electrode configuration using a plated through slot technique.

FIG. 3b shows a sectional view A-A of the embodiment in FIG. 3a.

FIG. 4a shows an exemplary differential capacitance keyboard key switch.

FIG. 4b shows a sectional view of the keyboard key switch in FIG. 4a.

FIG. 5 shows a computer mouse using differential capacitance sensing to detect a mouse button press.

FIG. 6a shows a touch pad using differential capacitive sensors as force sensors to detect a touch position.

FIG. 6b shows a sectional side view of the touch pad in FIG. 6a.

FIG. 7 shows a membrane keyboard key switch using differential capacitive sensing.

FIG. 8 shows a trigger mechanism using differential capacitive sensing.

FIG. 9 shows an alternative differential capacitive electrode configuration to detect an interfering member.

FIG. 10 shows an exemplary differential capacitive response to a change in position of the interfering member.

FIG. 11 shows a planar thumb stick using a differential capacitive sensing system.

FIG. 12 shows a planar differential capacitive electrode configuration for detecting a sliding interfering member.

FIG. 13 shows an exemplary differential capacitive electrode configuration to detect a rotating interfering member.

FIG. 14 shows a partial exploded view of a joystick using differential capacitive sensing.

FIG. 15 shows an alternative exemplary interfering member to be used for rotation measurement using differential capacitive sensing.

FIG. 16a shows a top view of an embodiment using differential capacitive sensing for rotation sensing.

FIG. 16b shows a sectional view A-A of FIG. 16a.

FIG. 17—Sectional view of a key switch influencing Tx1 and Tx2 simultaneously.

### DETAILED DESCRIPTION OF THE DRAWINGS

The description that follows is aimed at clarifying the methods and implementations in accordance with this invention in an exemplary manner and it is not meant to be exhaustive or limiting.

The methods and means described herein focus on the use of differential capacitance, but it should be noted that the same may be achieved by using the capacitive electrodes in the below embodiments to perform self- or mutual capacitance sensing instead of differential capacitance sensing.

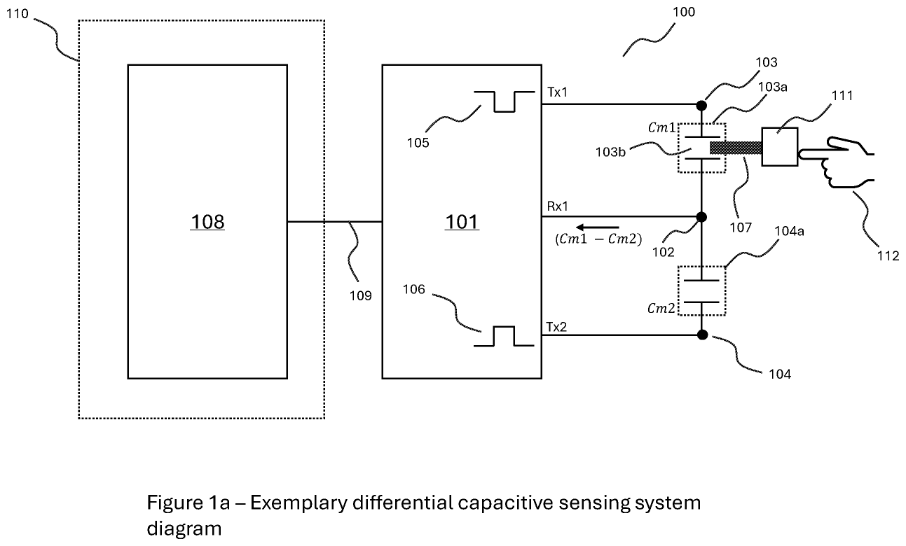

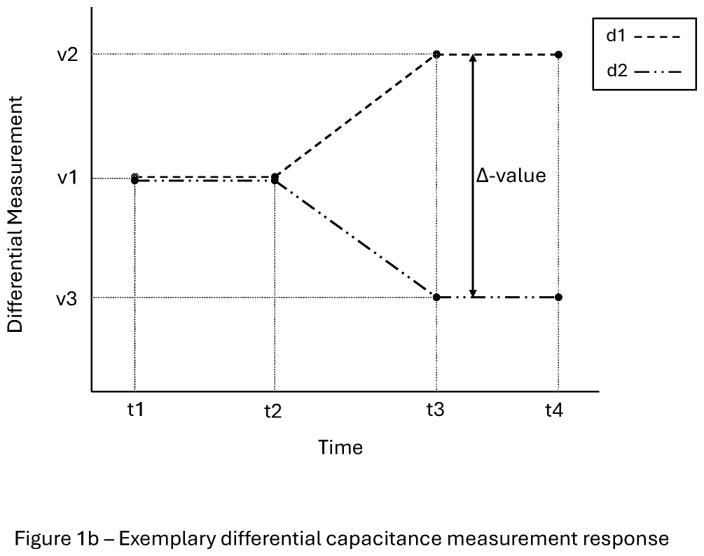

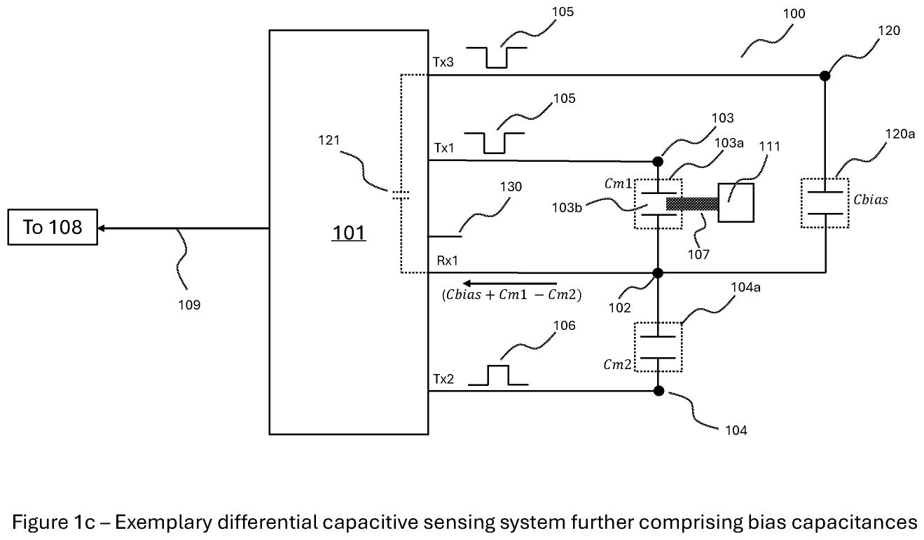

An exemplary differential capacitance sensing system 100 is shown in FIG. 1a that comprises of measurement circuitry 101 that is connected to a receiving (Rx) electrode 102, and also connected to a first transmitting electrode Tx1 (103) and a second transmitting electrode Tx2 (104). The Rx 102 forms a mutual capacitor 103a with Tx1 (103) having a mutual capacitance (or mutual coupling) Cm1. The Rx 102 also forms a mutual capacitor 104a with Tx2 (104) which has a mutual capacitance Cm2. A capacitive interfering member 107 is configured to interfere with the mutual capacitance Cm1 of capacitor 103a by moving into or out of a designated coupling volume 103b of the capacitor 103a. While it is shown in the figure that member 107 moves into the volume 103b of capacitor 103a, the same may be done for capacitor 104a instead of 103a.

Interfering member 107 may be chosen according to its dielectric constant (if a capacitive enhancing effect is required for the electrodes 102, 103 or 104). A higher dielectric constant will provide better sensing resolution and SNR. Interfering member 107 must also be chosen according to its temperature stability and moisture absorption properties, as a more temperature stable material with lower moisture absorption is preferable.

The designated coupling volume 103b may be defined as being any physical space between a Tx electrode (103 or 104) and the Rx electrode 102 which is designed such that a capacitive interfering member 107 may move into or out of the said space such that the corresponding mutual capacitive coupling is changed. In view of FIG. 1a, the capacitive interfering member 107 that moves into or out of (or both) the designated coupling volume 103b will lead to a change in the mutual capacitance Cm1, and said change is detectable by the measurement circuitry 101 via the Rx1 electrode. The capacitance interfering member 107 may be a capacitance enhancing member, such as a dielectric material, or a capacitance reducing device such as a metallic member that is grounded.

In one embodiment, the interfering member 107 is a made of a common material such as plastic, rubber, glass, ceramic, FR-4, etc. having a dielectric constant (or relative permittivity) that is somewhat greater than that of air (which has a dielectric constant of approximately 1), or the interfering member may be made from a specialized material such as Barium Titanate or Calcium Copper Titanate, both of which have very large dielectric constants and may thus cause a substantial change in Cm when the member 107 is moved relative to the capacitor 103a.

Measurement circuitry 101 may be any device capable of measuring a parameter or output value that is indicative of capacitances Cm1 and Cm2, for example an integrated circuit (IC) device, a microcontroller unit (MCU), a processor unit, etc.

In a preferred embodiment electrodes 102, 103 and 104 may be copper conductors on a printed circuit board (PCB) substrate such as flexible printed circuit board (FPCB) or a rigid substrate such as an FR-4 PCB, but is not limited to this configuration. For example, electrodes 102, 103 and 104 may be metallic or electrically conductive structures (such as pins, or metal tabs) that are attached to any supporting member (for example a plastic or FR-4 base member) and placed relative to each other such that the structures 102, 103 and 104 have mutual couplings as illustrated in FIG. 1a. More details on the physical electrode configuration will be discussed later in this disclosure.

The output value from capacitors 103a and 104a that may be measured on the Rx electrode 102 of the measurement circuitry 101 may be in the form of capacitance, voltage, electrical current, electrical charge, etc. and may be further interpreted as such within the measurement circuitry, or may be converted to another unit, for example ‘counts’ if charge transfer circuitry is used by circuitry 101.

In context of this disclosure, any reference made to measuring the capacitances of capacitors 103a or 104a shall be understood to automatically include the measurement of any other electrical parameters that are indicative of capacitance changes. Thus, the term ‘capacitance measurement’ shall not be construed to only obtaining a capacitance value, but may also include other electrical parameters as well, as is known in the art.

The measurements made by measurement circuitry 101 may be communicated via a connection 109 to another controller unit 108. Unit 108 may be another IC, microcontroller or even other measurement circuitry that forms part of an electronic device 110. For example, controller 108 may be a processor or a microcontroller of a computer mouse 110. As another example, controller 108 may be part of a handheld gaming controller 110. Measurement circuitry 101, although not illustrated as such, may also form part of and may be attached to the electronic device 110. The sensing system 100 may then be used to monitor a movable user interface member 111 that is coupled to the interfering member 107. For example, if the electronic device 110 is a computer mouse, the movable user interface member may be a mouse button or a mouse scroll wheel with which a user 112 interacts, thereby moving the user interface member 111 and by extension the interfering member 107 relative to the capacitor 103a, thus causing a measurable change in Cm1 that is detectable by circuitry 101.

Connection 109 may be a wired connection, such as UART, 12C, SPI or any other communication protocol as is commonly used by those skilled in the art. Alternatively, connection 109 may be wireless, utilizing Bluetooth®, Zigbee®, WiFi, etc. to communicate the measurements to processor 108.

Tx1 (103) may be driven by an excitation signal 105, while Tx2 may be driven by an excitation signal 106 in the same timeslot as signal 105. The excitation signal 105 may start at a high level, while the excitation signal 106 starts at a low level, and thereafter the polarities of both signals are changed, i.e. excitation signal 105 is at a low level while excitation signal 106 is at a high level. Thus, signals 105 and 106 may be seen as inverted relative to each other, and it is shown that Tx2 may be driven out-of-phase relative to Tx1 (103). Tx1 may be seen as being ‘in-phase’ in this configuration. The electrodes Tx1 (103) and Tx2 (104) may be driven out-of-phase with each other simultaneously and continuously until the end of a first measurement period, then the output value that is measured by the measurement circuitry 101 on the Rx1 electrode (102) will be related to Cm1-Cm2, i.e. the difference between the mutual capacitance of capacitor 103a and 104a. The signals 105 and 106 and Tx electrodes 103 and 104 may be part of measurement circuitry 101, or may be supplied by an external oscillation source (not shown) separate from the measurement circuitry 101.

In an alternative embodiment, only one excitation signal (105 or 106) is output by circuitry 101, which then inverted by means of a NOT-gate before being supplied to the other electrode.

The act of driving Tx1 (103) out-of-phase with Tx2 (104) results in the effective subtraction of Cm1 from Cm2, or Cm2 from Cm1 depending on which Tx starts the measurement with its polarity at a high level. For example, if Tx1 (103) is driven by a signal 105 that starts with a high level (e.g. 1 Volt) and Tx2 (104) is driven by a signal 106 that starts at a low level (e.g. 0 Volt), then this will lead to the effective subtraction of Cm2 from Cm1 (i.e. Cm1-Cm2). Conversely, if signal 106 starts with a high polarity and signal 105 starts with a low polarity, then this will lead to the subtraction of Cm1 from Cm2 (i.e. Cm2-Cm1). Importantly, this subtraction is external to measurement circuitry 101, and is due to the out-of-phase signals 105 and 106 applied to Tx1 and Tx2. As a result, the output value that is read by the measurement circuit 101 on Rx 102 is already indicative of the difference between Cm1 and Cm2, and the subtraction itself is external to the measurement circuitry. For this reason, it can be said that circuitry 101 has made a differential capacitance measurement or is measuring a differential output value from capacitors 103a and 104a. This is different from the prior art approach of measuring the Cm values directly, and then performing the subtraction function within the measurement circuitry 101.

A key benefit of performing a differential capacitance measurement in accordance with this invention is that common mode noise is reduced as part of the external subtraction. Furthermore, if the electrodes 102, 103 and 104 are positioned to be close to each other, environmental changes within the area of measurement (i.e. the area of the electrodes) are minimized too, since Cm1 and Cm2 may be similarly affected, and the common environmental effect is cancelled out by observing only the difference between Cm1 and Cm2.

While the aforementioned explains that the subtraction is dependent on which Tx signal 105 and 106 starts at a high level, it is more generally the case that it is dependent on the phase on which the measurement circuitry 101 samples the output value on the Rx electrode 102. For example, if the measurement circuitry 101 samples the Rx electrode 102 at times when the Tx1 signal is at a high polarity, then the output value that is measured on Rx 102 would be indicative of Cm1-Cm2. Conversely, if the measurement circuitry 101 samples the Rx electrode 102 at times when the Tx2 signal is at a high polarity, then the output value that is measured on Rx 102 would be indicative of Cm2-Cm1.

In FIG. 1b, an exemplary response of the output value (referred to here as a differential measurement) as measured by circuitry 101 e.g. an IC on Rx1 102 is shown. At time t1, the differential signal d1 measured by circuitry 101 is given by value v1. This may be shown on a channel of IC 101, as is typical for capacitive sensing. During time t1 to t2, user 112 does not interact with member 111, and so interfering member 107 is stationary. At time t2 to t3, user 112 interacts with interface 111 such that the interfering member 107 moves into the designated volume 103b of capacitor 103a. Assuming interfering member 107 is a dielectric material with a dielectric constant greater than that of air and assuming the designated volume 103b is an air volume, the gradual movement of member 107 into volume 103b will increase Cm1, which will lead to a increase in the differential signal d1 as illustrated from t2 to t3 (assuming that signal 105 starts with a high polarity such that Cm1-Cm2 is measured). The signal d1 would have decreased if the user 112 instead moved the member 111 such that the interfering member 107 fills less of the designated volume 103b.

Designated volume 103b may also be filled with another dielectric material with a relatively low dielectric constant, such as polypropylene, polyethylene, etc. Then, the interfering member 107 which has a dielectric constant that is greater than this filling material may displace the material as it moves into the designated volume 103b.

In an alternative embodiment, the differential capacitance sensing system 100 conducts more than one differential measurement using the same electrodes 102, 103 and 104. This may be done as follows: measurement circuitry 101 obtains a first differential capacitance measurement d1 on Rx 102 by driving Tx1 (103) with an excitation signal 105 which starts with a high polarity, and by simultaneously driving Tx2 (104) with an excitation signal 106 that is out-of-phase with signal 105. The first differential capacitance measurement d1 may thus be given by:

$$d 1 = Cm 1 - Cm 2.$$

A second differential capacitance measurement (d2) may then be obtained by circuitry 101 by repeating the measurement, with the only difference being that excitation signal 105 is applied to Tx2 and signal 106 is applied to Tx1. This may result in the signal d2:

$$d 2 = Cm 2 - Cm 1 ,$$

since Tx2 now has the signal that starts with the high polarity (‘in-phase’) and therefore Cm2 becomes the additive term in the d2 calculation while Cm1 becomes subtractive. The signal d2 may be assigned to a second channel on the IC 101. This is also illustrated in FIG. 1b, which shows the second differential measurement d2's response for the same user interaction with interface member 111 described earlier. Because only Cm1 is influenced as illustrated in FIG. 1a, differential measurement d2 will decrease to a value v3 approximately simultaneously to d1's increase. The measurement circuitry 101 may then further subtract (by means of physical circuitry or functions as part of firmware) d2 from d1 to obtain a delta (Δ) signal:

$$Δ = d 1 - d 2.$$

Alternatively, circuitry 101 may subtract d1 from d2. The Δ-value's sign, as well as the signs of d1 and d2 may be retained by the measurement circuitry to retain directional information (i.e. the measurement circuitry may store signed integers or signed floats to preserve negative number results). The Δ-value has the advantage of increased resolution and SNR of sensing the interfering member 107 compared to only monitoring d1 or d2. Nonetheless, the differential capacitive sensing system 100 may use any combination of d1, d2 and Δ-value to derive information regarding the interfering member 107 and by extension the user interface member 111.

The measurement circuitry 101, unit 108 or both may further perform digital signal processing on d1, d2 and Δ-value as necessary. Said signal processing includes filters such as infinite impulse response filters (IIR) filters, finite impulse response filters (FIR), exponentially weighted moving average (EWMA) filtering and so on. Said processing may further include debouncing and dead time responses. As is known in the art, measurement circuitry 101, unit 108 or both may use predetermined threshold values on the d1, d2 and Δ-value (or on all) in order to flag a state change relating to the movement or position of the user interface member 111.

In a preferred embodiment, the mutual capacitance Cm1 of mutual capacitor 103a is equal to or approximately equal to the mutual capacitance Cm2 of mutual capacitor 104a in the absence of interfering member 107. This may be referred to capacitance balancing or capacitance matching, and may be achieved through electrode design. For example, during the design and configuration of the electrodes 102, 103 and 104, the position, size, shape, spacing and dielectric materials can be chosen in order to have Cm1 equal to or approximately equal to Cm2. The better capacitors 103a and 104a are matched, the more environmental changes can be cancelled out from the d1 and d2 signals. Matched capacitors may have the further benefit that the d1 and d2 values read by the measurement circuitry 101 will result in the same or similar calibration values within circuitry 101, which may further contribute to the mitigation of environmental effects.

Capacitors 103a and 104a may also be balanced in terms of the electrical charge stored in them, which may be important if the IC 101 measures the difference in electrical charge specifically. It may occur that Cm1 and Cm2 differ slightly due to manufacturing tolerances on the electrodes and other factors, but this may be compensated for by altering the voltage of the signal 105 or 106, such that the total charge Q stored in capacitors 103a and 104a (according to the formula Q=CV) are equal or nearly equal.

The interfering member 107 may be shaped (e.g. in a triangle or pointed shape) in order to minimize the effect when the interfering member moves sideways and partially out of the electrodes 102, 103 or 104, due to tolerance or other jitter effects.

In a further embodiment, a positive biasing capacitance Cbias may be used to provide an offset to d1 and d2. This may be necessary due to the way certain measurement circuitry 101 performs their measurements on Rx electrode 102. If circuitry 101, for example, uses a charge transfer method of measurement, then some amount of charge is required to enter into circuitry 101 for the initial calibration procedure and during general operation when no interfering member is present. However, if Cm1 and Cm2 are balanced as noted in the foregoing paragraph, then d1 and d2 will be equal to zero or near zero, possibly leading to an error occurring in the circuitry 101. For this reason, a positive biasing capacitance may be used to offset d1 and/or d2 such that when no interfering member 107 is present, and if Cm1 is equal to Cm2 such that d1 and d2 are equal to zero or near zero, then measurement circuitry 101 is still able to continue measuring Cbias.

FIG. 1c provides an exemplary embodiment for implementing a Cbias capacitance. Measurement circuitry 101 may use a third transmitting electrode Tx3 with an electrode 120 that forms a mutual capacitor 120a with the Rx electrode 102. Said capacitor 120a may then have a mutual capacitance of value Cbias. The Tx3 electrode 120 may also be driven by the excitation signal 105, thereby being in-phase relative to Tx1, but out-of-phase relative to Tx2's excitation signal 106. Using this configuration, the first differential capacitance measurement d1 that is measured on Rx1 electrode 102 is given by:

$$d 1 = Cbias + Cm 1 - Cm 2.$$

If measurement circuitry 101 is configured to obtain a second differential capacitive measurement, then excitation signal 106 may still be applied to Tx1, and excitation signal 105 may still be applied to Tx2, but the excitation signal of Tx3 remains unchanged such that Cbias remains additive. The second differential capacitance measurement d2 is then given by:

$$d 2 = Cbias + Cm 2 - Cm 1.$$

It may be observed that if a Δ-value is to be calculated, Cbias is cancelled out. An important aspect of the above is that the excitation signal used for Cbias must be chosen such that it remains additive to the Rx electrode (102)'s reading. For this reason, it may be referred to as a positive biasing capacitance capacitor 120a.

The embodiment in FIG. 1c shows that the bias capacitor 120a is created in the form of an electrode 120 that couples with the Rx electrode 102, but this is not the only viable approach. In an alternative embodiment, the biasing capacitor 120a is in the form of a passive component such as a surface mount device (SMD) capacitor (for example COG-type) or a through-hole component. This may have the benefit of simplicity and capacitor 120a may remain unaffected by stray capacitance interference. If a COG-type capacitor is used, the sensing system 100 may have good environmental stability.

In a preferred embodiment, at least one internal capacitor 121 that is internal to/a part of the measurement circuitry 101 is used to implement Cbias, instead of having electrode 120 and external capacitance 120a. This offers flexibility, since these types of capacitors typically form part of a capacitor bank in an IC 101, and so Cbias is easily adjustable in firmware if implemented using internal capacitor(s) 121. In an alternative embodiment, a combination of internal and external bias capacitances is used.

In yet another alternative embodiment, a small capacitive bias may be implemented without the use of a dedicated Cbias as described in the aforementioned, by simply increasing the voltage of the excitation signal associated with the additive Cm component. For example, and with reference to FIG. 1a, excitation signal 105 which contributes to the additive term Cm1 of signal d1, may have a voltage of 1.1V, while the out-of-phase excitation signal 106 may have a voltage of 1V. In accordance with the known formula Q=CV, more electrical charge Q will be stored in Cm1 due to the higher V than in Cm2, leading to a slightly biased d1 signal. Alternatively, the voltage of the out-of-phase excitation signal may be lowered, either by the measurement circuitry 101 itself or by voltage reduction circuitry (not shown) external to circuitry 101.

Referring once more to FIG. 1c, another approach to implement Cbias is to use unused IO pins on the measurement circuitry or IC 101. An unused IO pin 130 that is adjacent to Rx1 may also be assigned as Tx3, and the Cbias is the capacitance that exists between pin 130 and Rx1, which is often sufficient, thereby also saving extra PCB routing and passive components.

In another embodiment, an unused IO pin such as 130 is assigned as the Tx2 electrode, and the mutual capacitance Cm2 is formed by the IO pin instead of having a dedicated electrode 104.

Embodiments will now be given that illustrate how the electrodes 102, 103, 104 and 120 may be configured for different applications.

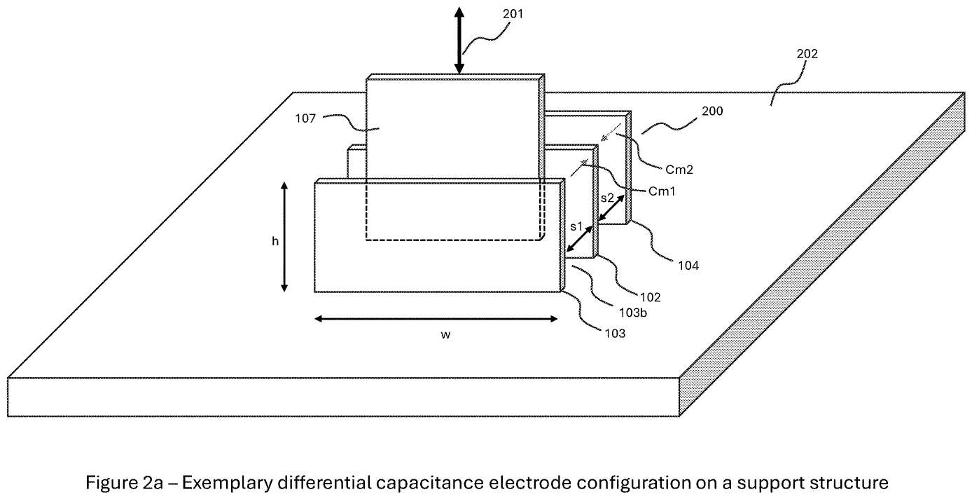

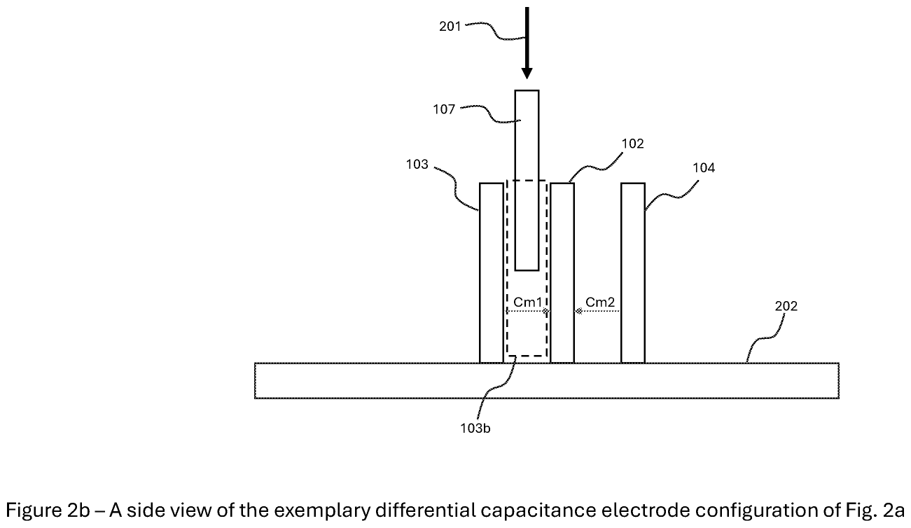

FIG. 2a shows an exemplary electrode configuration 200, wherein the electrodes 103, 102 and 104 are placed side-by-side to detect a vertically moving interfering member 107. A side view of the embodiment shown in FIG. 2a is shown in FIG. 2b. The Tx electrode 103 may be placed adjacent to the Rx electrode 102 to form a mutual capacitive coupling Cm1, while also leaving space for an interfering member 107 to move into or out of the designated coupling volume 103b, which is the space between electrodes 103 and 102. The Tx2 electrode 104 may be placed on the other side of the Rx electrode 102, to form a mutual capacitive coupling Cm2. A vertical force or movement 201 may act upon the interfering member 107 such that it moves downwards and into the designated coupling volume 103, which may exhibit the d1 and d2 signal response shown in FIG. 1b between t2 and t3. This is because, if the interfering member 107 is made of a material with a dielectric constant that is higher than that of air, Cm1 will increase. As a result, signal d1 will increase, but signal d2 will decrease, as shown in FIG. 1b. Alternatively, interfering member 107 may be moved upwards in this embodiment, which will decrease d1 and increase d2.

Referring once more to FIG. 2a, any movement of the interfering member 107 closer to the Tx electrode 103 or closer to Rx electrode may not significantly impact the overall measurement made by circuitry 101. If this movement does occur, measurement circuitry 101 may be outfitted with functions to correct for this behavior. In an alternative embodiment, dedicated electrodes may be placed to detect any unintended movement of member 107 along the width direction, which may then be compensated for by circuitry 101.

The electrode configuration in FIG. 2a may be used within the differential capacitive sensing system 100 to obtain various information regarding the interfering member. For example, measurement circuitry 101 may use the electrode configuration 200 to determine the vertical position of the interfering member 107 based on the d1, d2 or Δ-signal (or a combination thereof) obtained from the electrode configuration 200. Furthermore, circuitry 101 may derive further characteristics such as the vertical speed and acceleration of interfering member 107, and also force and weight information related to the actuation 201. The circuitry 101 may further relate this information to the movement of the coupled user interface member (not shown here).

The material of the interfering member 107 may be specifically chosen to maximize the change of Cm1 (or Cm2 if the designated volume 103b were between electrodes 102 and 104). For example, capacitance enhancing materials such as plastic, glass, rubber, ceramics and other common materials that have a dielectric constant greater than one may be used, and are fairly easy and cost effective to implement. However, it may be particularly beneficial to use a specialized material such as Barium Titanate with a high dielectric constant (typically with εᵣ≥1000). Another example of a specialized material includes Calcium Copper Titanate (typically with εᵣ≥10000). It may be advantageous to use a combination or a mixture of materials to form one unifying dielectric material, or use two or more discrete materials in member 107, to alter the profile of the d1 and d2 signals, as it moves into or out of the designated coupling volume 103b. For example, the bottom half of member 104 may be plastic, while the top half is ceramic, thereby creating a more pronounced detection signal at a stage when the member 107 is fully pressed into the designated coupling volume 103b.

In an alternative embodiment, the interfering member 107 may be made of an electrically conductive material, such as a metallic material (copper, aluminum, steel, iron, etc.) or a non-metallic but electrically conductive material such as a carbon coating or graphene. In this embodiment, the interfering member may be electrically floating or electrically grounded.

The physical shape of the interfering member 107 may be altered to suit the need of the application. For example, interfering member 107 may be triangular, circular, or even somewhat spherical to alter the profile of the d1 and d2 signals.

Similarly, the electrodes 102, 103 and 104 may be sized and shaped according to the need of the application. FIG. 2a does, however, illustrate a preferred embodiment of the configuration 200 to detect vertical movement and position change of member 107. The placement of the electrodes 102, 103 and 104 as shown in FIG. 2a provides a compact configuration thus minimizing its footprint in the application. The spacing between the electrodes 102, 103 and 104 may be chosen to accommodate a specific interfering member 107, and also to create a sufficient capacitive coupling Cm1 and Cm2 for the measurement circuitry 101 to measure. The sizes of the electrodes are also chosen to create sufficient coupling Cm1 and Cm2, as well as to accommodate the range of motion of the member 107. For example, the width w of the electrodes 102, 103 and 104 may be chosen to provide sufficient capacitive coupling for the sensing system 100, while the height h of the electrodes 102, 103 and 104 is chosen to accommodate the range of vertical motion of member 107. In a preferred embodiment, the spaces between electrodes 102, 103 and 104 (including the designated coupling volume 103b) are filled with air, to allow for the movement of interfering member 107.

Electrodes 102, 103 and 104 may be any general, electrically conductive structure, such as metallic tabs or plates, or even copper pours on/in a substrate. Electrodes 102, 103 and 104 may be further placed or attached to a support structure 202. The support structure may, for example, be a plastic base plate to which the electrodes 102, 103 and 104 are attached. In another embodiment, support structure 202 is a printed circuit board substrate (such as FR-4), which is convenient since circuit board traces may then be used to connect the electrodes 102, 103 and 104 to the measurement circuitry 101 which may also be placed on the support structure 202. For example, electrodes 102, 103 and 104 may be aluminum, copper or any other metal plates that are attached to the support structure, using any well-known attachment method (e.g. soldered, glued, press-fit, etc.).

An important aspect of the electrode configuration 200 in FIG. 2a is that the capacitive coupling which is not influenced by the interfering member 107 remains clear of any other materials or members that can alter its mutual capacitance.

In one embodiment, it may be beneficial to position the interfering member 107 such that it already overlaps with the electrodes 102 and 103 at its resting position, that is, is already somewhat inserted into the coupling volume 103b (for example as a starting position). This way, any position change of member 107 that follows is immediately detectable by circuitry 101.

In a preferred embodiment, the Tx1 electrode 103 and Tx2 electrode 104 are similarly shaped, and equally spaced from the Rx electrode 102, that is, electrodes 102 and 104 have equal or similar heights h and widths w dimensions, and the spacings s1 and s2 are equal or similar. This way, the aforementioned balanced or matched capacitor configuration is achieved, wherein Cm1 is equal to or approximately equal to Cm2, which further leads to effective temperature mitigation. If this balancing is not possible and Cm1 differs from Cm2, the voltages of signals 105 and 106 may be adjusted to equalize the total electrical charge Q stored between electrodes 102 and 103, and 102 and 104.

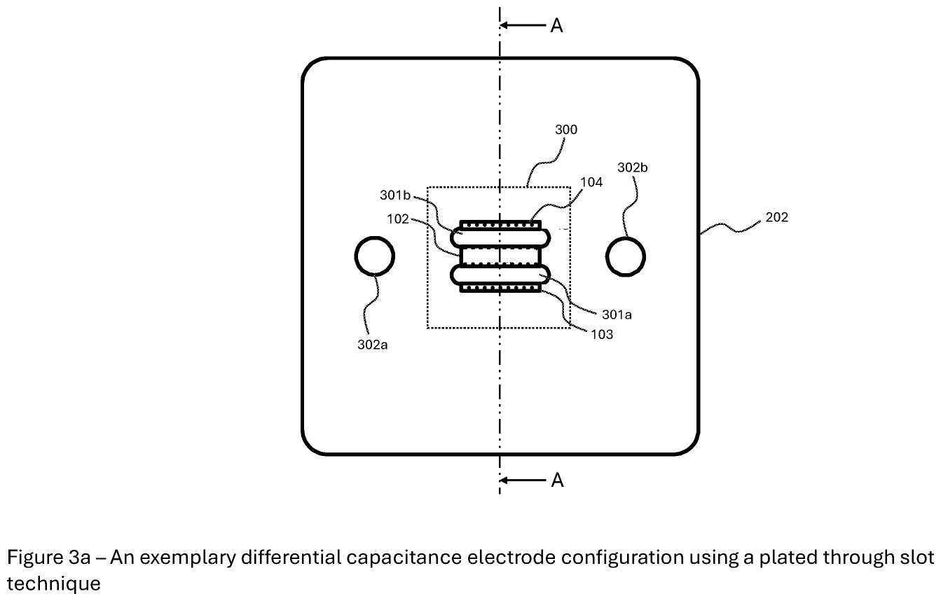

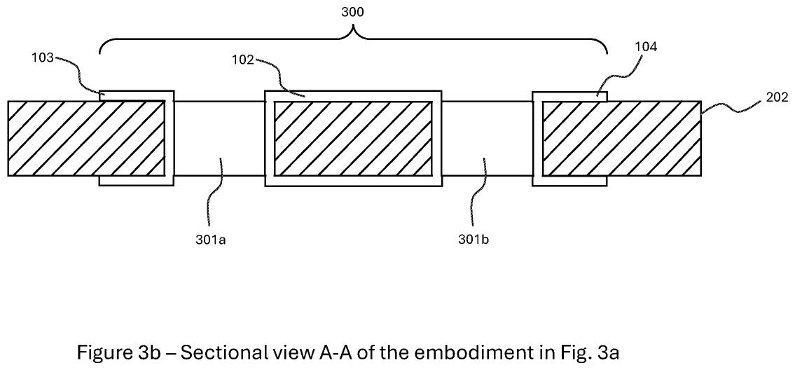

In FIG. 3a, an exemplary embodiment of a differential capacitive electrode configuration 300 is shown (top-down view), which comprises a Tx1 electrode 103, a Tx2 electrode 104 and also an Rx electrode 102 between the Tx electrodes. In this embodiment, the electrodes 102, 103 and 104 are embedded into the support structure 202, and the spacing between the electrodes comprises holes (or slot cut-outs) 301a and 301b in the support structure 202 that form capacitive coupling zones. One of the holes (301a or 301b) may then be chosen as the designated coupling zone for an interfering member (not shown) to move into or out of to alter the mutual capacitance and by extension, d1, d2 or the Δ-value as measured by measurement circuitry 101 (not shown here). Support structure 202 may further contain mounting holes 302a and 302b, in order to mount a mechanism (not shown) that supports the moving user interface member 111 to which the interfering member 107 is attached.

FIG. 3b shows a sectional view A-A of FIG. 3a for further illustration of the embodiment. In a preferred embodiment, the support structure 202 is a printed circuit board substrate such as FR-4, and the electrodes 102, 103 and 104 are copper pours or copper plating that is achieved via edge castellation. In another preferred embodiment, slots 301a and 301b are plated-though slots in the PCB 202, and the electrodes 102, 103 and 104 form the plated parts of the plated-through slots 301a and 301b. Although not illustrated in FIG. 3a, a plurality of electrode sets such as the configuration 300 can be placed on the same PCB 202 to form a sensor array for a keyboard, and the plurality of electrode sets may be measured using the same measurement circuitry 101.

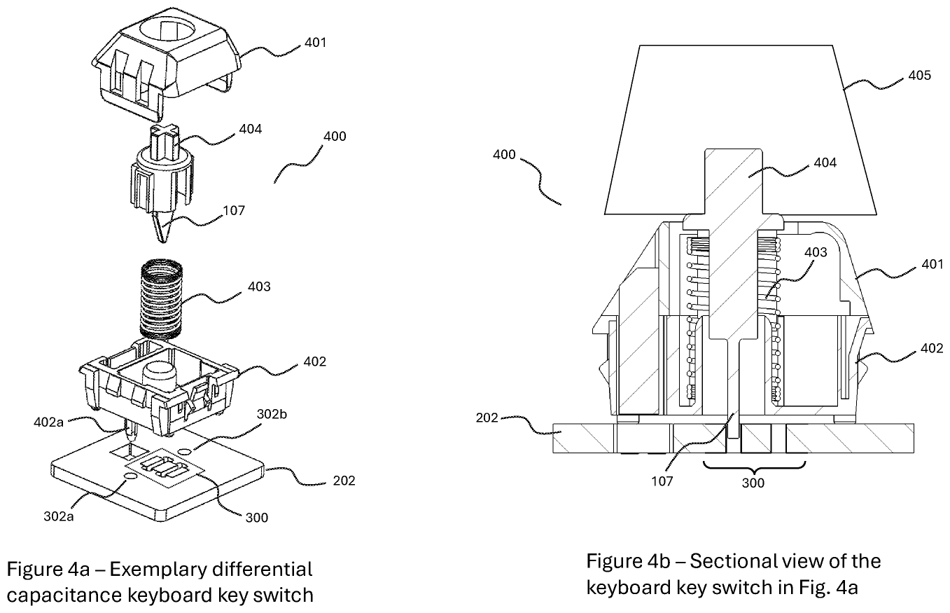

With the embodiments in FIGS. 2a to 3b illustrating the means to perform vertical position sensing of an interfering member 107 using a differential capacitive sensing system 100, one application is to monitor the key presses of a keyboard switch 400, which is shown in exploded view form in FIG. 4a. The switch 400 may comprise the typical components including a hood 401 and a base 402. The base 402 may mount to the support structure 202 by means of pins 402a and 402b that latch onto the support structure via the holes 302a and 302b. Electrode set 300 (or electrode configuration 300) from FIG. 3a is positioned such that the interfering member 107 that is attached to or a part of a movement translation member 404 aligns with one of the slots in the electrode set 300. The switch may also comprise a restoring member 403 to restore the interfering member 107 and the user interface member 111 to neutral, unpressed positions. The key switch cap 405 is shown in the sectional view A-A of FIG. 4b, and acts as the user interface member 111 of the electronic device 110 being the keyboard (or the switch itself). It may also be seen in FIG. 4a that the interfering member 107 is shaped to alter the profile of the d1, d2 and/or Δ-signal of the key switch 400. Analytics such as the press and release profile, as well the press period of the switch and the depth of the press may be derived from the measurements made by measurement circuitry 101. Key switch 400 may be one of a plurality of key switches, which may all use the differential capacitive sensing system 100, with one or more measurement circuitry devices 101.

Switch 400 may still have an ohmic switch closure to denote that the key is pressed (as is known in the art), while the differential capacitive sensing system 100 monitors other keys switch movement properties. The sensing system 100 may, for example, be used for calibrating the desired range of motion of the key switch 400 (or any other of the embodiments disclosed herein).

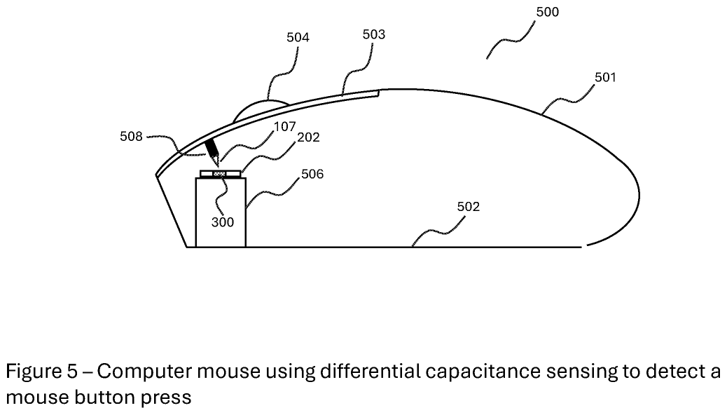

In FIG. 5, an alternative embodiment is shown where the electrode configuration is applied in a computer mouse 500 (equivalent to electronic device 110) having a top shell 501 and a bottom base piece 502. The mouse 500 further has at least one input structure (button) 503 and may also have a scroll wheel 504. Both the button 503 and the scroll wheel 504 may be depressible by a user, and therefore may be considered as user input members 111. The button 503 may further comprise a mounting point 508 to which the interfering member 107 is attached. When a user presses the button 503, the interfering member may move into a designated coupling volume of the differential capacitance electrode configuration/set 300 on a support structure 202, which is further supported by a piece 506 that is part of the mouse base plate 502. This embodiment allows for the differential capacitance measurement system 100 to be used to detect the position, speed and acceleration of button 503, as well as the force with which the button is pressed. The movement characteristics of button 503 may then be interpreted to assign a button press event such as a click, double click and so on to forward to the mouse controller unit 108. Piece 506 may also be attached to the shell 501 of mouse 500. Since the scroll wheel 504 is depressible, the same sensing system 100 may be applied to detect scroll wheel press events.

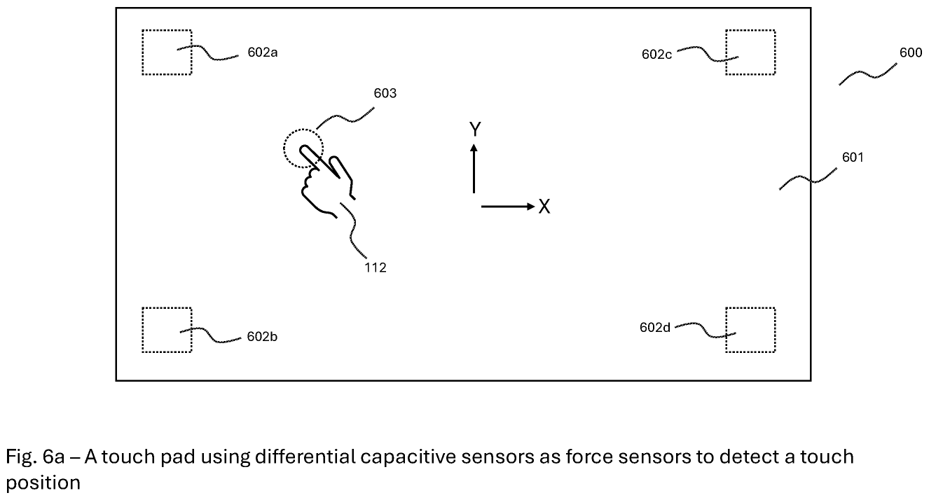

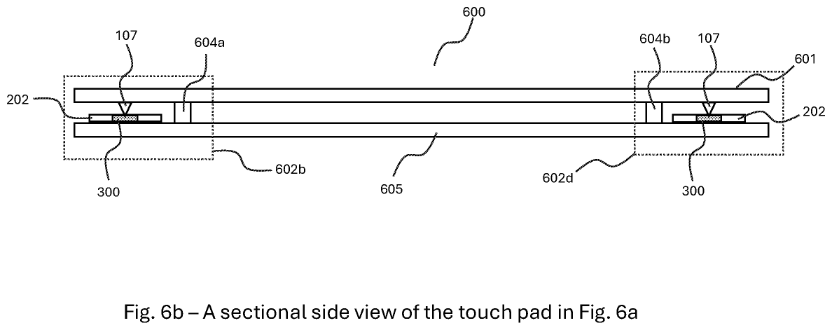

In yet another embodiment shown in FIG. 6a and FIG. 6b, the differential capacitance system 100 is used to create a plurality of force sensors 602a, 602b, 602c and 602d in a force sensing trackpad/touch pad 600 of a laptop or computer (equivalent to device 110) to detect the force of a press on the pad 600. A touchpad or trackpad 600 may have a touch surface layer (or a force-receiving layer) 601, which is equivalent to user interface member 111, on which a user 112 may execute a press at a XY position 603. The trackpad may further have elastic support members 604a and 604b attached to a base support member 605 of the device 110 (said device 110 referring either to the trackpad 600 itself or the device to which pad 600 is attached) to restore the touch surface layer 601 to its neutral position after a press. The force of press at a position 603 is translated via the user interface member 111 to the force sensors 602a, 602b, 602c and 602d. The trackpad 600 itself or the device 110 of which it forms a part may comprise a host controller unit 108, which may calculate the XY position 603 based on the readings of the force sensors 602a, 602b, 602c and 602d.

It follows that each of the force sensors 602a, 602b, 602c and 602d may comprise a differential capacitance electrode set 300, as illustrated in FIG. 6b, said electrode set 300 being part of a support structure 202. Each force sensor 602a, 602b, 602c and 602d may comprise an interfering member 107. A single or multiple instances of the measurement circuitry 101 may be used to monitor the vertical position of the interfering member 117 of each force sensor 602a, 602b, 602c and 602d, in order to derive the force with which the user has pressed upon the surface 601 and also to calculate the XY position 603 of the user press from the d1, d2 or Δ-signal (or a combination thereof).

Up to this point the electrode configurations that were illustrated followed a parallel capacitor-style configuration, i.e. the electrodes 102, 103 and 104 are configured as parallel plates and the Cm1 and Cm2 capacitances are formed between the plates. It is, however, possible to have a differential capacitive sensing system 100 that comprises measurement circuitry 101 which uses planar-style electrodes 102, 103 and 104, wherein the Cm1 and Cm2 couplings are dominated by fringing electric fields, and the designated coupling volume is chosen as one of the areas in which a fringe field is exposed.

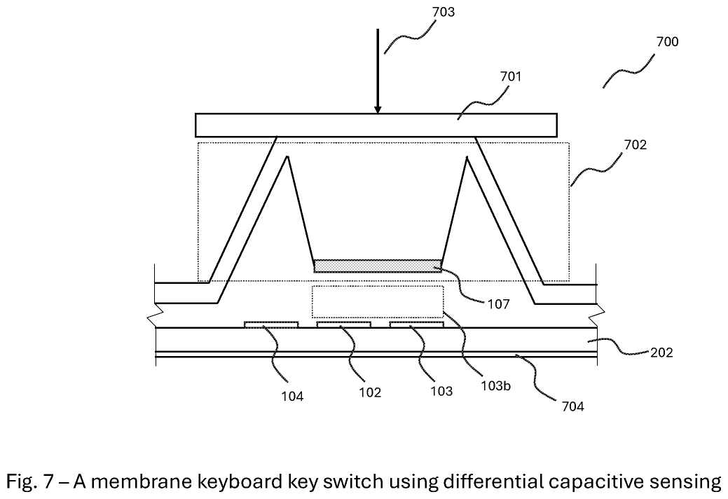

The aforementioned planar-style differential capacitive sensing system is illustrated in FIG. 7 in the form of an elastically domed membrane key switch 700. The switch 700 comprises a key cap 701 (equivalent to user interface member 111) that is attached to an elastic dome 702 with flexible walls that collapse or flex when pressure is applied in a direction 703 onto key cap 701 by a user 112, but recovers to its original position when pressure is removed. An interfering member 107 may be attached to the elastic dome 702 in order to interfere with the mutual coupling Cm1 between the Tx1 electrode 103 and the Rx electrode 102, both of which may be in the form of electrically conductive traces on a support structure 202. The support structure 202 may be in the form of a FR-4, FPC or Polyethylene Terephthalate (PET) layer. The structure 202 may have a GND plane 704 to protect the electrodes 102, 103 and 104 from stray interference. The electrodes 102 and 103 are thus positioned according to the position of the elastic dome 702, for the purpose of exposing the mutual coupling Cm1 occurring in the fringe field area 103b (which is also the designated coupling volume 103b to be interfered with) to the interfering member 107 when the dome 702 collapses or flexes under pressure. When the latter happens, the Cm1 coupling in volume 103b changes, while the Cm2 coupling between the Tx2 electrode 104 and the Rx electrode 102 remains unchanged. As discussed earlier, a change may then be observed by the measurement circuitry 101 in the d1, d2 and Δ-value, and information regarding the analogue position, speed, acceleration and key press status (on/off) of the interfering member 107 and by extension the key switch 700 may be registered and forwarded to the master controller unit 108 of the keyboard device 110 of which key switch 700 forms a part of. While the movement of key 700 is described being a ‘collapse’ due to its snap-like movement, it is possible for the differential capacitive system 100 to obtain an analog vertical position reading of the key switch 700 for a ‘pressed but not collapsed’ state.

In the embodiment of FIG. 7, the interfering member may, as described in the aforementioned embodiments, be a capacitive enhancing dielectric material, such as rubber, plastic, ceramic, etc. In this instance, the interfering member 107 will strengthen the Cm1 coupling as it overlaps more with the designated coupling zone 103b when key 700 is pressed. A d1, d2 and Δ-value response similar to that shown in FIG. 2 may be expected (but more non-linear) and used to obtain position and movement information regarding switch 700.

In a preferred embodiment, however, interfering member 107 is an electrically conductive material, which may include metallic materials such as copper, aluminum, etc. or non-metallic materials such as silicone conductive material that contains carbon, as is typical for the conductive pills or pucks (i.e. interfering member 107) used in rubber keypads. In this instance, interfering member 107 acts like a floating conductor that moves closer to the electrodes 102 and 103, which increases the Cm1 coupling as member 107 approaches the electrodes 102 and 103, since the interfering member 107 now acts as an additional capacitive coupling path from electrode 103 to 102 apart from the normal fringe coupling. The d1-signal is expected to increase, while the d2-signal may decrease.

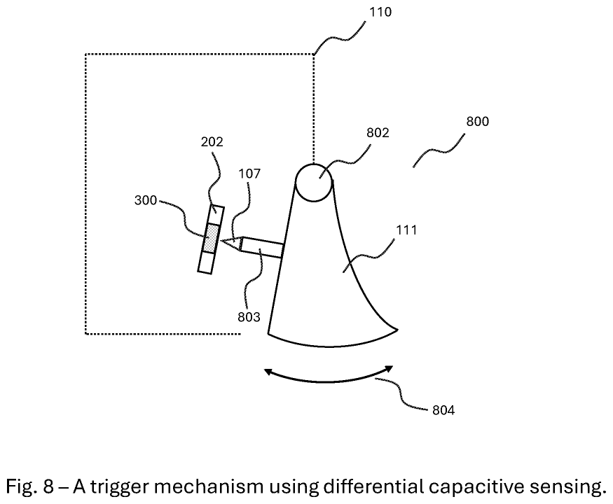

In FIG. 8, an embodiment is illustrated wherein the differential capacitive sensing system 100 is used to sense the position and movement of a trigger user interface. A trigger mechanism 800 is shown to have a user interface member 111 in the form of a trigger member that pivots about a point 802. The trigger mechanism may be part of an electronic device 110 such as a gamepad/handheld gaming controller, a power tool such as an electric drill, photography device requiring shutter control, or any general input device. An interfering member 107 may be attached to the trigger 111 via a mounting member 803 (which may also be part of trigger 111). When the trigger 111 moves in the direction 804 due to a user (not shown) interaction with trigger 111, the interfering member 107 may move into the differential capacitive electrode set 300 that is supported by the support structure 202. The measurement circuitry 101 that measures the electrode set 300 may be attached to the support structure 202 within device 110, or may be attached to another PCB within device 110. The master controller 108 may also be attached to support structure 202, or on another PCB within the device 110. The support structure 202 itself is also mechanically supported by other parts of the device 110, as is typical for sensors in devices. The differential capacitive system 100 may therefore be used to derive the position, speed, velocity, acceleration, angular velocity, angular position or angular acceleration of the trigger 111 based on the measurements d1, d2 or Δ-value (or any combination thereof) to inform the device 110 of the state of trigger 111.

In an alternative embodiment, the trigger (or user interface member) 111 need not pivot about a point 802, but may also be configured in device 110 to have straight, linear movement, which makes the movement trajectory of interfering member 107 similar to that of the previously described embodiments.

It should also be noted that for this embodiment, the previously described embodiments and the embodiments that follow, that the interfering member 107 and the user interface member 111 may be the same piece, or may also be made of the same material. Furthermore, interfering member 107, the user interface member 111 and the mounting member 803 or 508 may also be part of the same piece and need not be separate components.

The electrode configuration shown in FIG. 2a illustrates that the electrodes 102, 103 and 104 may be placed side-by-side such that a major surface of the Tx1 electrode 103 faces a first major surface of the Rx electrode 102, and also such that a major surface of the Tx2 electrode 104 faces a second major surface of the Rx electrode 102. An embodiment will now be shown where a major surface of the Tx1 electrode 103 and a major surface of the Tx2 electrode face the same major surface of the Rx electrode, to accommodate horizontally moving or pivoting interfering members.

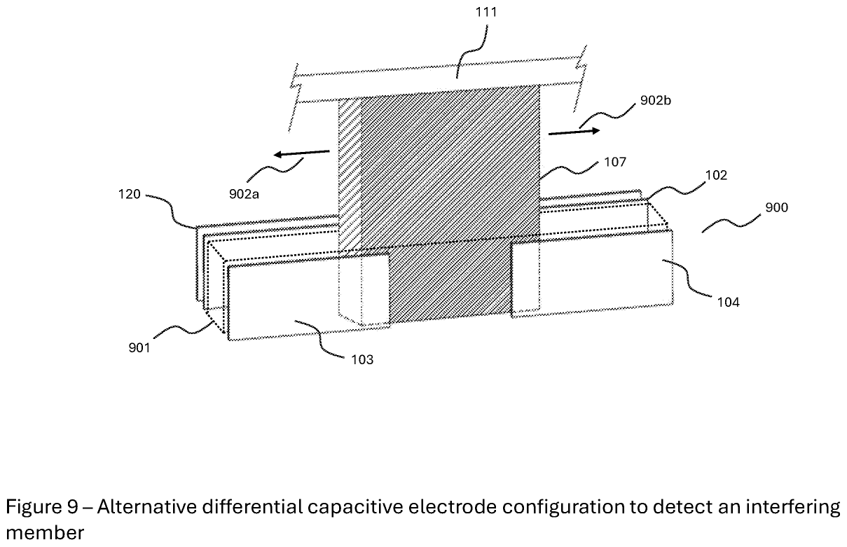

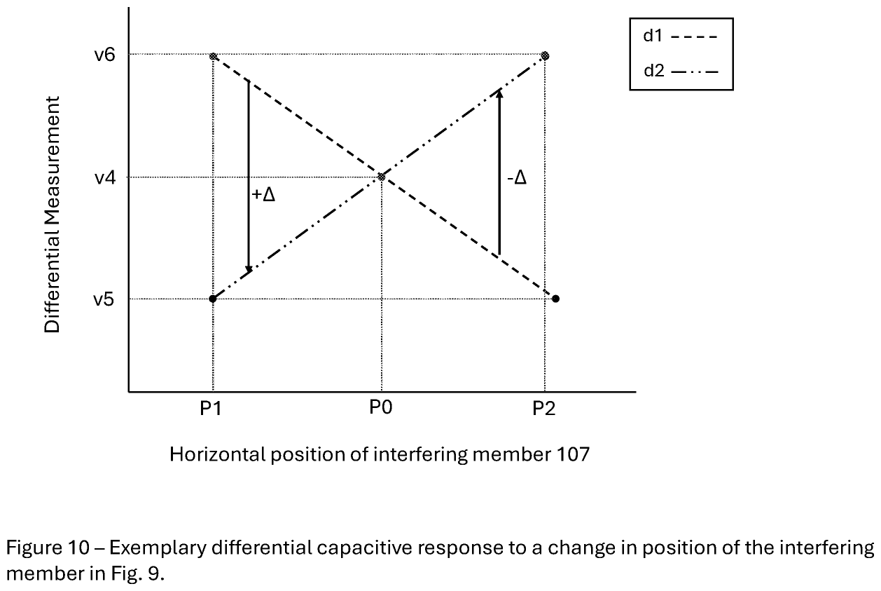

An electrode configuration 900 is shown in FIG. 9, which comprises a Tx1 electrode 103, a Tx2 electrode 104 and a Rx electrode 102. An interfering member 107 is positioned in the space between the Tx electrodes 103, 104 and the Rx electrode 102. Furthermore, the interfering member 107 partially overlaps with the Tx electrode 103, and also partially overlaps with the Tx2 electrode 104, thereby partially influencing the mutual coupling Cm1 and Cm2 simultaneously. The designated coupling volume 901 is now defined by the combination of the mutual capacitive coupling volumes of both Tx electrodes 103 and 104, as indicated in FIG. 9. Therefore, the electrode configuration 900 allows for the interfering member 107 to influence Cm1 and Cm2 simultaneously, in order to detect horizontal movement (in directions 902a and 902b) of the interfering member 107. Note that while this embodiment is used for horizontal movement sensing of interfering member 107, those skilled in the art may easily reposition member 107 and the electrode configuration 900 for vertical or diagonal movement sensing.

A bias electrode 120 is placed on the side of the Rx electrode 102 that is opposite of the side on which the Tx electrodes 103 and 104 are placed. The inclusion of the bias electrode 120 is optional, and may also be implemented using any of the aforementioned variants regarding the inclusion of a biasing capacitance (120a or 121).

As with the previous embodiments, the size, shape and spacing of the electrodes 102, 103 and 104 must be designed to accommodate sufficient movement of interfering member 107, while being optimally influenced by the member 107. The designated coupling volume 901 is preferably air, and the electrode configuration 900 may be attached to a support structure 202 (similar to what is illustrated in FIG. 2a) or be embedded into a support structure 202 (similar to what is illustrated in FIGS. 3a and 3b) using the plated through-slots approach if structure 202 is a PCB.

The d1 and d2 signal responses of the electrode configuration 900 may look different than that shown in FIG. 1b, since Cm1 and Cm2 are both influenced simultaneously which further exaggerates the rate of change observed in d1 and d2 and by extension, the Δ-value. An exemplary signal response is shown in FIG. 10, which shows how the d1 and d2 measurements change as a function of the horizontal position of interfering member 107 in FIG. 9.

For the electrode configuration 900, the measurement circuitry 101 may conduct a first differential measurement d1 wherein the Tx1 electrode 103 is excited by signal 105 and the Tx2 electrode 104 is excited by an out-of-phase signal 106, such that d1=Cm1−Cm2. When the interfering member 107 is at position P0, which is the position illustrated in FIG. 9 and which may be defined by the fact that there is an equal (or approximately equal) amount of overlap with both Tx electrodes 103 and 104, the d1 measurement may result in a measurement value v4. After the first measurement, a second differential measurement may be conducted by the measurement circuitry 101 wherein the out-of-phase signal 106 is assigned to Tx1 and the in-phase signal 105 to Tx2, such that the measured d2 is given by d2=Cm2-Cm1. Due to the equal amount of overlap of member 107 with the Tx electrodes 103 and 104 in FIG. 9, the d2 measurement will also result in a measurement value equal to or approximately equal to v4, and thus d1=d2, or d1=d2 at P0.

If the interfering member moves in the direction 902a to a position P1, which is defined by a majority or complete overlap of the Tx1 electrode 103, then the d1 measurement increases to a value v6, since this movement led to an increase in Cm1 and simultaneously a decrease in Cm2. The d2 measurement may decrease to a value v5 due to the aforementioned changes to Cm1 and Cm2. Assuming the Δ-value is calculated by the measurement circuitry as A=d1−d2, then a positive delta value of v6-v5 may be calculated. The ‘+’ sign of the delta may indicate the direction of the movement of the interfering member 107 as being in direction 902a.

If the interfering member moves in the direction 902b to a position P2, which may be defined by a majority or complete overlap of the Tx2 electrode 104, then d1 measurement may decrease to a value v5, since this movement led to an increase in Cm2 and simultaneously a decrease in Cm1. The d2 measurement may increase to a value v4 due to the aforementioned changes to Cm1 and Cm2. The Δ-value is now given by v5-v6 resulting in negative Δ-value. The ‘−’ sign of the delta may now indicate that the direction of the movement of the interfering member 107 as being in direction 902b.

To this end, the d1, d2 and Δ-values may be used by the measurement circuitry to derive position, speed, velocity, acceleration, horizontal force, etc. information of the interfering member 107 and by extension the user interface member 111. As mentioned previously, the shape and material of the interfering member 107 may be altered for a more non-linear or other specific response in FIG. 10.

In one embodiment, the interfering member 107 may overlap with approximately half of the total area of Tx electrode 103, and also overlaps with approximately half of the total area of Tx electrode 104 when at position P0. In this case, when the interfering member moves to a full overlap with any one of the Tx electrodes 103 or 104, then the Tx electrode 103 or 104 that loses overlap may do so for the full range of movement of member 107.

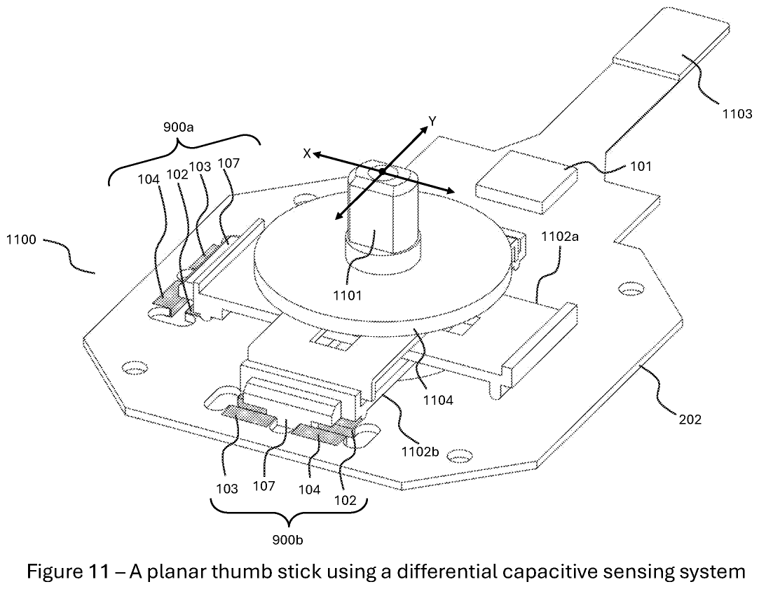

In FIG. 11, a planar joystick (or more generally thumb stick) embodiment is shown that uses the differential capacitive sensing system 100 to determine the XY position of the force lever of the joystick. A planar joystick 1100 may comprise of a force lever 1101 (that may be seen as a user interface member 111) that has a base member 1104. The force lever 1101 is movable in an X and Y direction, or a combination thereof by a user (not shown). Lever arms 1102a and 1102b may be coupled to the lever 1101 to translate a receiving force on the lever to the Y-position sensor 900a and X position sensor 900b respectively. Sensors 900a and 900b each comprise a Tx1 electrode 103, a Tx2 electrode 104 and an Rx electrode 102 in the style of the embodiment shown in FIG. 9, but that is a plated-through slot configuration applied to PCB 202. The measurement circuitry 101, shown herein as an IC 101, may be connected to the electrodes of sensors 900a and 900b. The IC 101 together with the sensors 900a and 900b may be regarded as the differential capacitance measurement system. The PCB 202 has a connector 1103 to form a connection 109 to a master processor 108 of the electronic device 110 (which in this case may be the game input device or handheld controller). The shown position of lever 1101 may be regarded as the neutral position, characterized by the approximately equal overlap that the interfering member 107 has with the Tx1 electrode 103 and with the Tx2 electrode 104. In this embodiment, the d1 measurement, d2 measurement, or the calculated Δ-value (with or without the sign) may be used to derive the XY position of the lever 1101, as well as the speed, acceleration, velocity or force exerted on the lever 1101. It should be noted that the interfering member 107 and the arm 1102a or 1102b to which it is attached may be one piece. A restoration member (not shown) may be used to restore the lever 1101 of joystick 1100 to its neutral position.

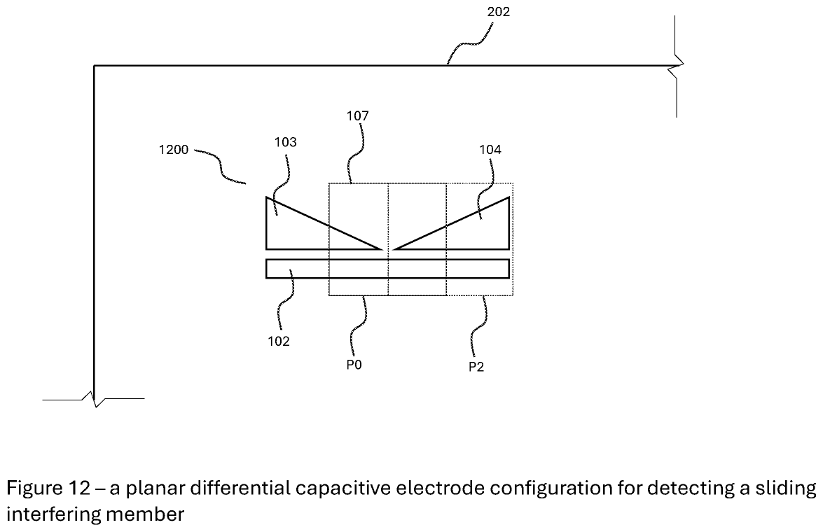

A planar electrode configuration 1200 is shown in FIG. 12, which shows a top-down view of a planar Rx electrode 102 as a copper pour on a PCB 202, as well as Tx1 electrode 103 and Tx2 electrode 104 which are also planar PCB electrodes in the shape of triangles. An interfering member 107 may vertically overlap with electrodes 102, 103 and 104 at a neutral position P0. The interfering member may move planarly to a position P2 where maximum overlap occurs with electrode 104 while no overlap occurs with electrode 103. Interfering member 107 may be made of a dielectric material or an electrically conductive material that is electrically floating, both of which will lead to an increased mutual capacitive coupling Cm2 when in position P2. Interfering member may move in the direction of electrode 103 as well to increase the mutual capacitive coupling Cm1. The movement of the interfering member 107 in either direction may will affect the d1 and d2 signals. The embodiment of FIG. 12 shows that the Tx electrodes 103 and 104 may be triangular shaped, but may also take on other shapes, including basic rectangular shapes similar to that of the Rx electrode 102. The shapes of the electrodes 102, 103 and 104 may be chosen by the designer to achieve a specific response of d1, d2 and by extension the Δ-value.

To minimize friction, a gliding layer such as Mylar (not shown) may be inserted on top of the planar electrodes 102, 103 and 104 and below the interfering member 107. However, in this case, the interfering member 107 is required to be an electrically floating conductive material to obtain a sufficiently measurable signals d1 and d2 from the electrodes 102, 103 and 104.

The sliding/gliding configuration of differential capacitive sensing to other applications requiring the measurement of a sliding measurement. It should also be noted that it may be beneficial to use the electrode configuration 1200 in the planar joystick 1100 shown in FIG. 11 instead of the plated through-slot electrode sets 900a and 900b. This may be done for cost effectiveness, and also to further promote compactness.

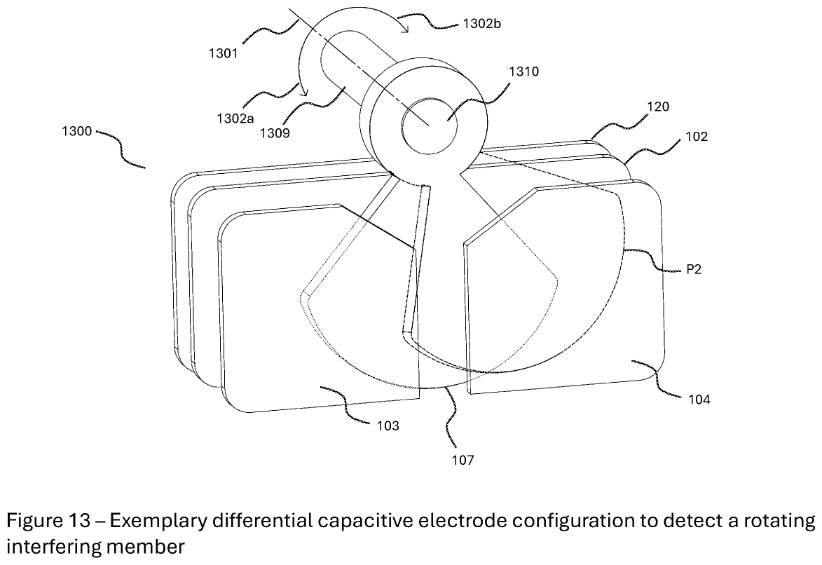

FIG. 13 shows how the electrode configuration in FIG. 9 may be used to monitor the position and movement of an interfering member 107 that rotates about an axis 1301 in a direction 1302a or 1302b. If a user (not shown) were to apply a force on a user interface member (not shown here) such that the axis rotates in the direction 1302a, then the interfering member may rotate to a position P2, thus overlapping more with the Tx2 electrode 104 and thereby increasing Cm2 if the interfering member were to be made of dielectric material. The measurement circuitry 101 that is connected to electrodes 102, 103 and 104 may calculate the angle of rotation in direction 1302a or 1302b, the speed of the rotation, acceleration of the rotation, force or torque related to movement of the interfering member, etc. from the d1, d2 or Δ-value signal.

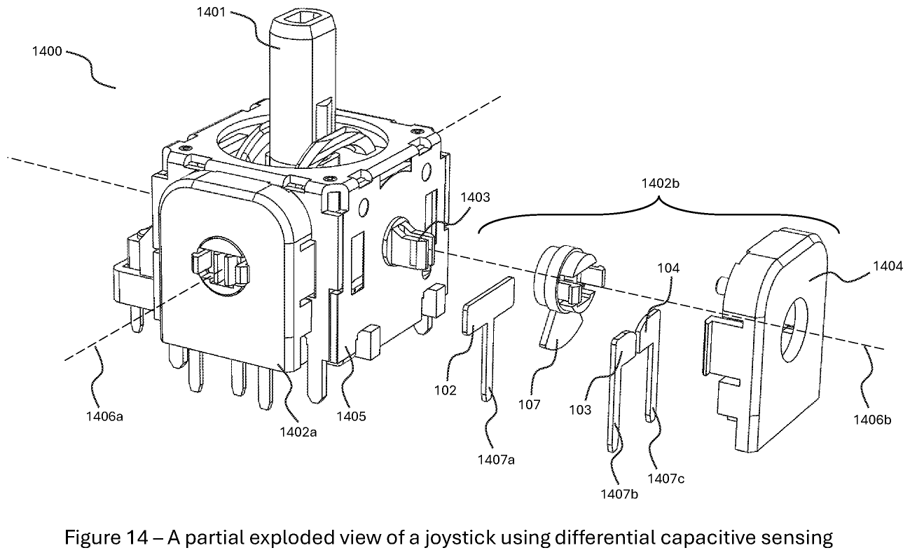

Electrode configuration 1300 may be applied in a joystick/thumb stick application as shown in FIG. 14, which illustrates a joystick or thumb stick device 1400 that comprises a lever 1401 and an outer structure 1405 to which sensor modules 1402a and 1402b may be attached. An exploded view of sensor module 1402b is given and comprises an Rx electrode 102, a Tx1 electrode 103, a Tx2 electrode 104, a rotatable interfering member 107 and a module cover 1404. The module cover 1404 may latch onto the outer structure 1405 and may hold the electrodes 102, 103 and 104 and also the interfering member 107 in place. The interfering member 107 itself may be attached onto a rotatable mounting point 1403. Lever 1401 may have attached to it a user interface member such as a lever cap (not shown) which a user (not shown) may apply a force to, thereby tilting the lever about the axis 1406a, or 1406b or a combination thereof. The lever 1401 may also be regarded as a user interface member 111 as a cap is not required. Measurement circuitry 101 (not shown here) may be used to measure the differential capacitance d1 and d2 of each sensor module 1406a and 1406b. The sensor module 1402a may indicate the angle of rotation of lever 1401 about axis 1406a, while the sensor module 1402b is used to measure the angle of rotation of lever 1401 about axis 1406b. The electrodes 102, 103 and 104 are shown to have pin members 1407a, 1407b and 1407c designed to be soldered onto or plugged into a PCB (not shown) via a through-hole interface. The measurement circuitry 101 may then use the d1, d2 or Δ-value signal from sensor modules 1402a and 1402b to determine the angle of rotation/tilt, direction of rotation/tilt, speed of rotation/tilt, force on the lever 1401, torque on lever 1401 and the cartesian coordinate result of the joystick lever 1401 tilt based on the rotation of the lever 1401 about axes 1406a and 1406b.

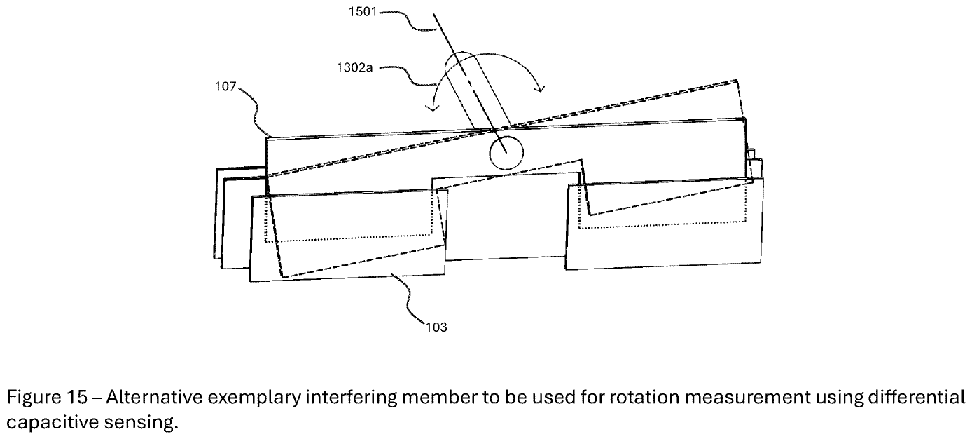

As previously mentioned, the shape of the interfering member may be altered to achieve alternative d1 and d2 profiles, which are partly a function of how the interfering member 107 overlaps with the Tx electrodes 103 and 104 as it moves or rotates. FIG. 15 shows an alternative embodiment wherein an interfering member that increases its overlap with Tx electrode 103 as it rotates in a direction 1302 about an axis 1501. In this instance, the rotation in direction 1302a increases the Cm1 coupling, whereas in FIG. 13, the Cm1 coupling decreases, due to how the interfering member is shaped.

The differential capacitive sensing system 100 may also be used in applications where a user interface device is a rotating device, such as a knob or a dial. For example, in the embodiment shown in FIG. 13, a knob or dial (not shown) may be attached to the end 1310 of shaft 1309 to form a differential capacitive sensing system 100 that is used to monitor the angle of rotation of the knob or dial, for example for a musical mixer board, a volume button on a radio, etc.

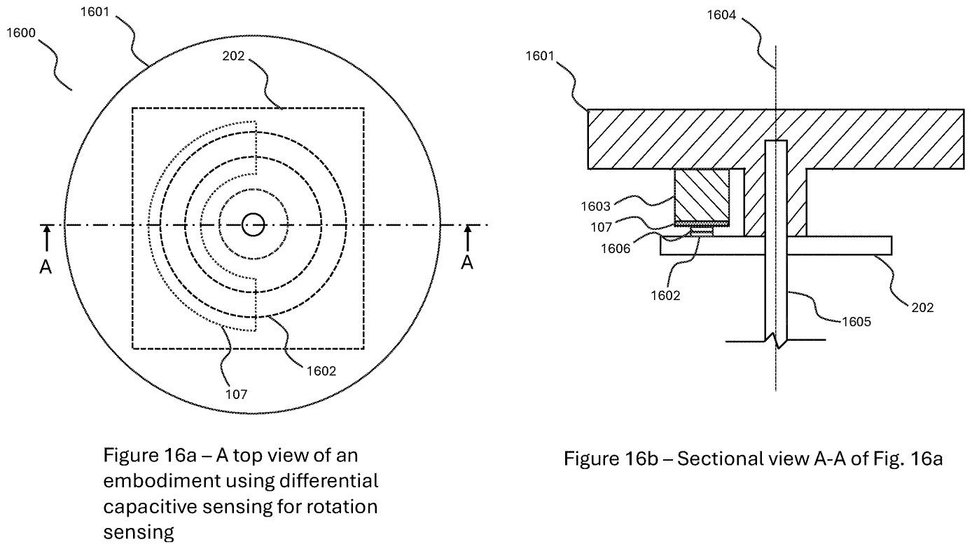

FIGS. 16a and 16b show a rotary differential capacitive interface device 1600 comprising a knob or dial 1601 (equivalent to the user interface 111) that may be either attached to a shaft 1605 which rotates within a supporting structure 202, or the dial 1601 may be rotatably movable on the shaft 1605 while the shaft 1605 itself is fixed relative to the support structure 202. The dial may rotate about an axis 1604. The support structure 202 may further comprise planar differential capacitance electrodes 1602, which may take the form of planar electrodes 1200 that are extended along the path of rotation about axis 1604 up to 360 degrees, thereby forming a circular planar sensor. A spacer member 1603 (which may also form one piece with the dial 1601) may be used to vertically position the interfering member 107 above the differential capacitive electrodes 1602. A separation layer 1606 (such as Mylar) may be placed in between the interfering member 107 and the electrodes 1602.

In this embodiment, the interfering member 107 may be an electrically floating conductive material such as aluminum or a carbon mixture. In the same way as described in the embodiment of FIG. 12, electrodes 1602 may be used to derive rotation position, speed, etc. using measurement circuitry 101.

The differential capacitive system 100 may be used in the interface system 1600 to determine the absolute rotation position of dial 1601. This may be done by designing the Tx1, Tx2 and Rx electrodes 1602 to be unique at each position along the path of rotation, i.e. varying the electrode widths. However, if a sensor embodiment such as 1200 is used, it may occur that some of the measurement points along the path of rotation result in the same differential capacitive measurement, and may therefore be indistinguishable from each other. For this reason, the height of the interfering member 107 above the electrodes 1602 may be made non-constant, i.e. vary along the path of rotation in addition to the varying widths of the Tx1 and Tx2 electrodes, such that a unique absolute rotation position of dial 1601 may be determined by circuitry 101. This may be achieved by designing the spacer member 1603 to have a gradually increasing or decreasing height along its radial arc.

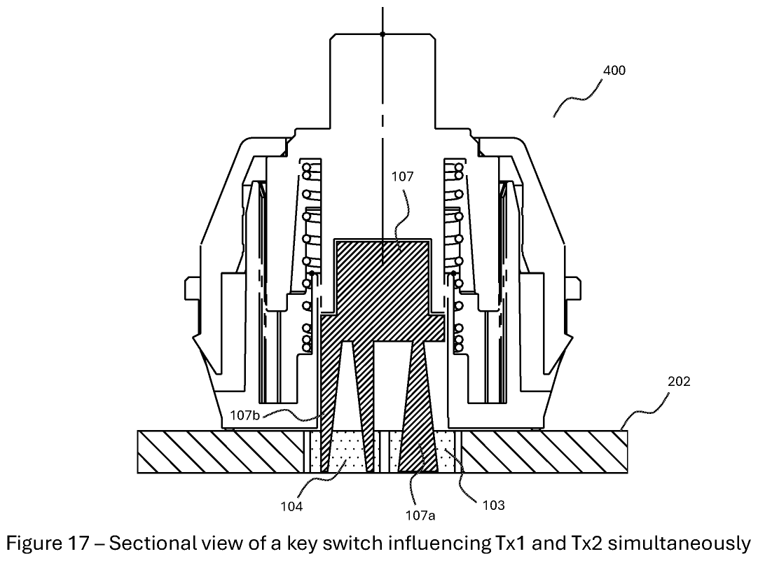

FIG. 17 illustrates how the electrode configuration of FIG. 9 can also be used for vertical position sensing, using the example of a key switch 400. The interfering member 107 is shown to be shaped such that if key 400 is pressed, then the portion 107a that overlaps with the Tx1 electrode 103 reduces in area overlap, while the portion 107b of interfering member 107 increases in area of overlap with Tx2 electrode 104. This also produces a simultaneous change in Cm1 and Cm2, which is observable in d1, d2 and the delta-signal by measurement circuitry 101.

We claim the following:

1. A differential capacitive sensing system in an electronic device with a movable user interface member, said system comprising a receiving electrode, a first transmitting electrode forming a first mutual capacitor with the receiving electrode, a second transmitting electrode forming a second mutual capacitor with the receiving electrode, and measurement circuitry which is configured to drive the second transmitting electrode out-of-phase with the first transmitting electrode to perform a subtraction of capacitances relating to the first and second mutual capacitors external to the measurement circuitry, the measurement circuitry further configured to read a value related to the capacitance of the receiving electrode that is indicative of the resulting differential capacitance, and wherein the measurement circuitry is configured to measure the differential capacitance when movement of a capacitive interfering member that is coupled to or is part of the user interface member, interferes with the capacitance of the first or second mutual capacitor, said measured differential capacitance being a metric related to the position of the interfering member.

2. The differential capacitive sensing system of claim 1, further comprising a positive biasing capacitance to positively bias the measured differential capacitance.

3. The differential capacitive sensing system of claim 1, wherein the first and second mutual capacitors are balanced to have an equal or nearly equal amount of capacitance in the absence of the interfering member.

4. The differential capacitive sensing system of claim 1, wherein the first and second mutual capacitors are configured to store an equal or nearly equal amount of electrical charge by one or both of the following:
a. designing the first and second electrodes to form similar mutual capacitive coupling with the receiving electrode, and
b. altering the voltage level of an excitation signal that drives the first or the second transmitting electrode.

5. The differential capacitive sensing system of claim 1, wherein the interfering member is made from a non-metallic material with a relative permittivity greater than 50.

6. The differential capacitive sensing system of claim 5, wherein the interfering member is made from Barium Titanate or Calcium Copper Titanate.

7. The differential capacitive sensing system of claim 1, wherein the measurement circuitry is configured to obtain a second differential capacitance measurement from the receiving electrode by driving the first transmitting electrode out-of-phase with the second transmitting electrode, and wherein the measurement circuitry is configured to use the combination of the first and the second differential capacitance measurements.

8. The differential capacitive sensing system of claim 1, wherein the capacitive interfering member simultaneously influences the first and second mutual capacitors.

9. The differential capacitive sensing system of claim 1, wherein the electronic device is a keyboard, and the user interface member is a key on the keyboard, and wherein the measured differential capacitance is related to a user interaction with the key on the keyboard.

10. The differential capacitive sensing system of claim 1, wherein the electronic device is a joystick or thumb stick, and the user interface member is a lever on the joystick, and wherein the differential capacitance measurement is related to a user interaction with the lever of the joystick or thumb stick.

11. The differential capacitive sensing system of claim 1, wherein the electronic device is a mouse, and the user interface member is a mouse button or mouse scroll wheel, and wherein the differential capacitance measurement is related to a user press event on the mouse button or on the mouse wheel of the computer mouse.

12. The differential capacitive sensing system of claim 1, wherein the electronic device is a force sensing pad or touch pad, and the user interface member is a force-receiving surface, and wherein the differential capacitance is related to a user press event on the force-receiving surface of the force sensing pad or touch pad.

13. The differential capacitive sensing system of claim 1, wherein the user interface member is a rotatable knob or dial and wherein the differential capacitance is related to a rotational movement caused by user interaction with the knob or dial.

14. The differential capacitive sensing system of claim 13, wherein the first and second transmitting electrodes are planar PCB electrodes that vary in width along a path of rotation sensing.

15. The differential capacitive sensing system of claim 14, wherein a height of the interfering member above the first and second transmitting electrodes and the receiving electrode varies along the path of rotation, and wherein the differential capacitive measurement is used to determine the absolute rotation position of the knob or dial.

16. The differential capacitive sensing system of claim 1, wherein the differential capacitive measurement is used to determine one or more of the following properties regarding the interfering member:
a. The position of the interfering member
b. The angle of the interfering member
c. The speed or velocity of the interfering member
d. The acceleration of the interfering member
e. The force or torque related to the movement of the interfering member.

17. A method of performing differential capacitive sensing in an electronic device with a movable user interface member, the method comprising the steps of providing a receiving electrode, a first transmitting electrode forming a first mutual capacitor with the receiving electrode, a second transmitting electrode forming a second mutual capacitor with the receiving electrode, and measurement circuitry, configuring the measurement circuitry to drive the second transmitting electrode out-of-phase with the first transmitting electrode to perform a subtraction of capacitances relating to the first and second mutual capacitors external to the measurement circuitry, configuring the measurement circuitry further to read a value related to the capacitance of the receiving electrode that is indicative of the resulting differential capacitance, and of configuring the measurement circuitry to measure the differential capacitance when movement of a capacitive interfering member that is coupled to or is part of the user interface member, interferes with the capacitance of the first or second mutual capacitor, said measured differential capacitance being a metric related to the position of the interfering member.

18. The method of claim 17, further comprising the step of using a positive biasing capacitance to positively bias the differential capacitive measurement.

19. The method of claim 17, further comprising the steps of configuring the measurement circuitry to obtain a second differential capacitance measurement from the receiving electrode by driving the first transmitting electrode out-of-phase with the second transmitting electrode, and of configuring the measurement circuitry to use the combination of the first and the second differential capacitance measurements.

20. The method of claim 17, further comprising the step of balancing the first and second mutual capacitors to have an equal or nearly equal amount of capacitance in the absence of the interfering member.
